(19) United States
(12) Patent Application Publication
(10) Pub. No.: US 2017/0031326 A1
(43) Pub. Date: Feb. 2, 2017

(54) ELECTRONIC DEVICE

(71) Applicant: Kabushiki Kaisha Toshiba, Tokyo (JP)

(72) Inventors: Hirofumi Omote, Adachi Tokyo (JP); Meri Ueda, Yokohama Kanagawa (JP)

(21) Appl. No.: 14/971,420

(22) Filed: Dec. 16, 2015

Related U.S. Application Data
(60) Provisional application No. 62/199,509, filed on Jul. 31, 2015.

(51) Int. Cl. G04G 21/02; G04B 37/14

(52) U.S. Cl. CPC G04G 21/025; G04B 37/1486

(57) ABSTRACT

According to one embodiment, an electronic device includes a housing and a sensor. The housing is independent from a device having a main function of an apparatus. The housing is configured to be attached to a part configured to be worn around one part of a human body of the apparatus. The sensor is accommodated in the housing and configured to detect biological information of the human body.

### CROSS-REFERENCE TO RELATED APPLICATIONS

This application is based upon and claims the benefit of priority from U.S. Provisional Application No. 62/199,509, filed on Jul. 31, 2015 the entire contents of which are incorporated herein by reference.

### FIELD

Embodiments described herein relate generally to an electronic device.

### BACKGROUND

For example, a wearable device of a wristwatch type or an eyeglass type is known. In the wristwatch type wearable device, a component such as a substrate and a sensor may be accommodated inside a case of the wristwatch.

### BRIEF DESCRIPTION OF THE DRAWINGS

FIG. 1 is a perspective view illustrating a wristwatch and a healthcare device of a first embodiment;

FIG. 2 is a perspective view illustrating the healthcare device of the first embodiment;

FIG. 3 is a cross-sectional view illustrating the healthcare device of the first embodiment;

FIG. 4 is a perspective view illustrating a variant of the healthcare device of the first embodiment;

FIG. 5 is a perspective view illustrating a wristwatch of a second embodiment; and

FIG. 6 is a perspective view illustrating the wristwatch of the second embodiment from another direction.

### DETAILED DESCRIPTION

According to one embodiment, an electronic device includes a housing and a sensor. The housing is independent from a device having a main function of an apparatus. The housing is configured to be attached to a part configured to be worn around one part of a human body of the apparatus. The sensor is accommodated in the housing and configured to detect biological information of the human body.

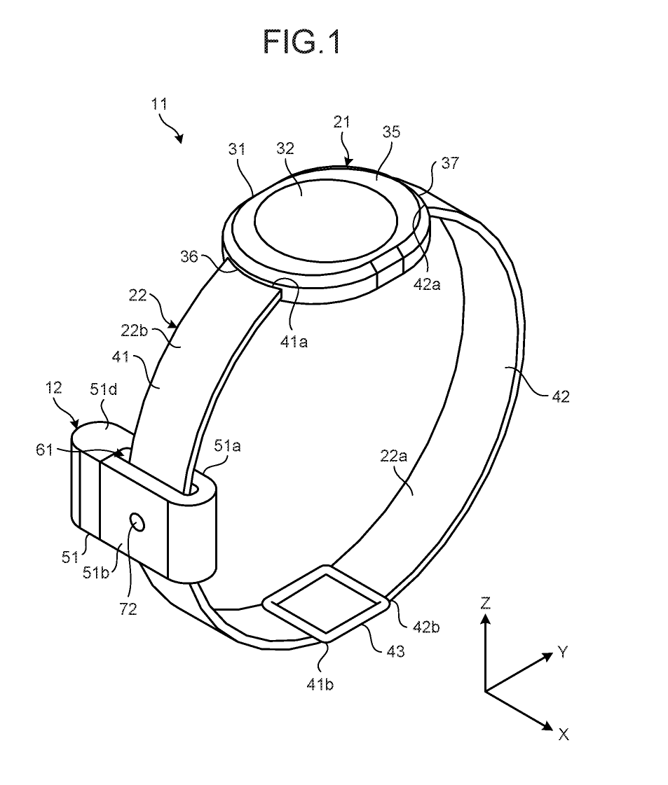

A first embodiment will be hereinafter described with reference to FIGS. 1 to 4. A plurality of expressions may be given on constituent elements according to the embodiment and the descriptions on such elements. Other expressions that are not described are not inhibited from being made on such constituent elements and descriptions. Furthermore, other expressions are not inhibited from being made on the constituent elements and descriptions on which the plurality of expressions is not made.

FIG. 1 is a perspective view illustrating a wristwatch 11 and a healthcare device 12 of a first embodiment. The wristwatch 11 is an example of a wristwatch and an apparatus, and may also be referred to as, for example, a device, an instrument, a tool, an accessory, and a wear. The healthcare device 12 is an example of an electronic device in the first embodiment, and may also be referred to as, for example, an apparatus, a device, and a component.

The wristwatch 11 includes a display unit 21, and a watchband (watchstrap) 22. The display unit 21 is an example of a display unit and a device, and may also be referred to as, for example, an apparatus, a main body, a function unit, a component, and a portion. The watchband 22 is an example of a watch band and a part configured to be worn around one part of a human body, and may also be referred to as, for example, a strap, a belt, a bracelet, a holding unit, a wearable unit, a component, and a portion.

As illustrated in each figure, in the present specification, an X-axis, a Y-axis, and a Z-axis are defined. The X-axis, the Y-axis, and the Z-axis are orthogonal to each other. The X-axis lies along a width of the display unit 21. The Y-axis lies along a length of the display unit 21. The Z-axis lies along a thickness of the display unit 21.

The display unit 21 includes a watch housing 31 and an information display unit 32. The watch housing 31 may also be referred to as, for example, a housing, a case, and a cabinet. The information display unit 32 may also be referred to as, for example, a display unit, a screen, and a portion.

The wristwatch 11 displays various information such as, for example, time, date, and day of the week on the information display unit 32. For example, if the wristwatch 11 is an analog watch, the information display unit 32 displays time with an hour hand, a minute hand, and a second hand; whereas if the wristwatch 11 is a digital watch, the information display unit 32 displays time with a liquid crystal display. The information display unit 32 is not limited thereto, and for example, may display other information such as age in months, temperature, humidity, atmospheric pressure, and biological information of a user of the wristwatch 11.

The wristwatch in the present specification is not limited to a wristwatch that displays information such as time, date, and day of the week, and includes various devices such as a so-called wristwatch type wearable device. In other words, the wristwatch includes a computer, a portable audio device, a game machine, an accessory, and a toy equipped with the display unit capable of displaying various information including time and the watchband attached to the display unit.

The watch housing 31 accommodates various components for displaying the information on the information display unit 32, for example. For example, if the wristwatch 11 is an analog watch, the watch housing 31 accommodates a movement, whereas if the wristwatch 11 is a digital watch, the watch housing 31 accommodates a substrate and various electronic components. The watch housing 31 is not limited thereto, and may accommodate other components such as a battery and an antenna for communicating with the healthcare device 12.

The watch housing 31 includes a display face 35, a first end portion 36, and a second end portion 37. The display face 35 is oriented in a direction along the Z-axis. The information display unit 32 covered with a glass is provided on the display face 35. The first end portion 36 is the one end of the watch housing 31 in the direction along the Y-axis. The second end portion 37 is the other end of the watch housing 31 in the direction along the Y-axis.

The watchband 22 holds the wristwatch 11 at the wrist of the user, for example. The watchband 22 may hold the wristwatch 11 at other portions. The watchband 22 includes a first watchband 41, a second watchband 42, and a buckle 43.

The first watchband 41 and the second watchband 42 are made, for example, of an elastomer. The first and second watchbands 41, 42 are not limited thereto, and may be made of other materials such as, for example, leather, cloth, metal, and a combination thereof.

The first watchband 41 includes a first basal end portion 41a and a first distal end portion 41b. The first basal end portion 41a is an example of a first end portion. The first distal end portion 41b is an example of a second end portion.

The first basal end portion 41a is detachably attached to the first end portion 36 of the watch housing 31 of the display unit 21. Thus, the first watchband 41 is extended from the first end portion 36 of the watch housing 31. The first basal end portion 41a may be fixed to the display unit 21, for example. The first distal end portion 41b is located on the opposite side of the first basal end portion 41a.

The second watchband 42 includes a second basal end portion 42a and a second distal end portion 42b. The second basal end portion 42a is an example of a third end portion.

The second basal end portion 42a is detachably attached to the second end portion 37 of the watch housing 31 of the display unit 21. Thus, the second watchband 42 is extended from the second end portion 37 of the watch housing 31. The second basal end portion 42a may be fixed to the display unit 21, for example. The second distal end portion 42b is located on the opposite side of the second basal end portion 42a.

The buckle 43 is attached to the first distal end portion 41b of the first watchband 41. The buckle 43 may be attached to the second distal end portion 42b of the second watchband 42. The buckle 43 detachably fastens the second watchband 42 to the first watchband 41. The display unit 21 and the watchband 22 form a substantially annular shape, as illustrated in FIG. 1, when the second watchband 42 is fastened to the first watchband 41 with the buckle 43.

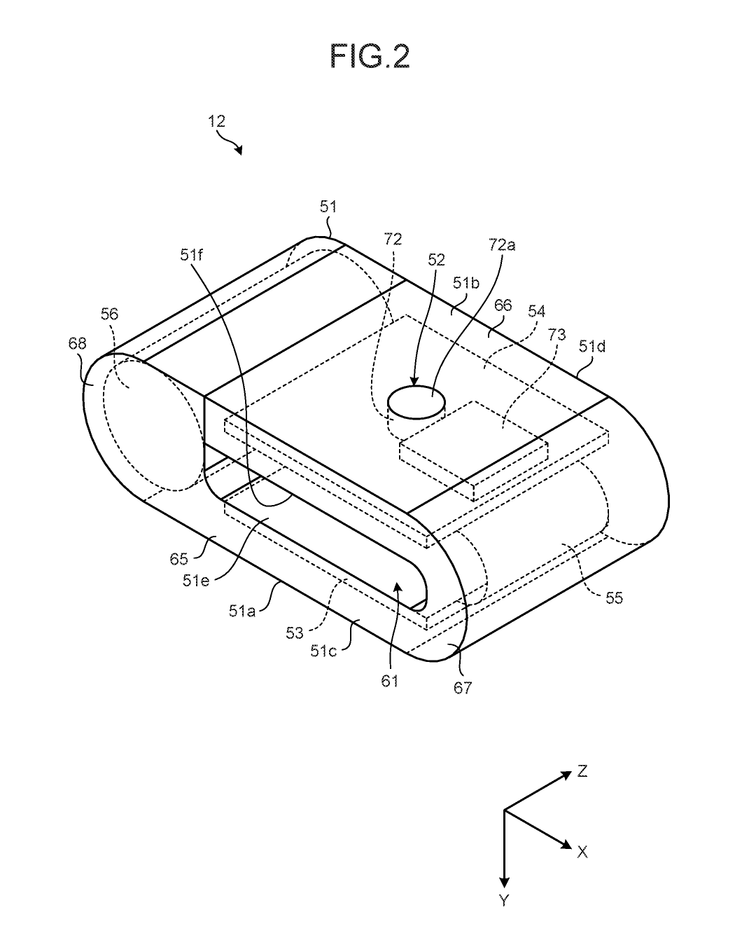

FIG. 2 is a perspective view illustrating the healthcare device 12 of the first embodiment. As illustrated in FIG. 2, the healthcare device 12 includes a housing 51, a sensor 52, a first substrate 53, a second substrate 54, a flexible cable 55, and a battery 56.

The housing 51 may be referred to as, for example, a case, a cabinet, a sealing unit, and a portion. The sensor 52 may be referred to as, for example, a sensing unit, a detecting unit, and a component. The first and second substrates 53, 54 may be referred to as, for example, a component. The flexible cable 55 is an example of a cable, and may also be referred to as, for example, a component. The battery 56 may be referred to as, for example, a power supply, a supplying unit, and a component.

The housing 51 is made, for example, of an elastomer. The elastomer in the present specification is a synthetic resin, and includes, for example, a macromolecular organic compound having elasticity such as natural rubber, synthetic rubber, silicon rubber, and fluorine containing rubber. The housing 51 may be made, for example, of a plurality of materials containing elastomer, and other materials.

The sensor 52, the first substrate 53, the second substrate 54, the flexible cable 55, the battery 56, and various components are embedded in the housing 51 made of elastomer. The housing 51 accommodates the sensor 52, the first substrate 53, the second substrate 54, the flexible cable 55, the battery 56, and the various components by being integrally molded with the sensor 52, the first substrate 53, the second substrate 54, the flexible cable 55, the battery 56, and the various components. The housing 51 is not limited thereto, and may be formed to a box shape, for example, and the sensor 52, the first substrate 53, the second substrate 54, the flexible cable 55, the battery 56, and the various components may be accommodated therein.

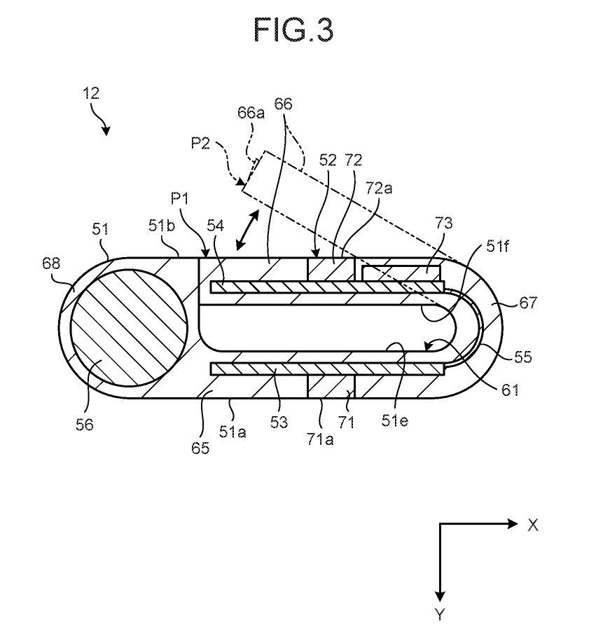

FIG. 3 is a cross-sectional view illustrating the healthcare device 12 of the first embodiment. As illustrated in FIGS. 2 and 3, the housing 51 includes a first surface 51a, a second surface 51b, a first side face 51c, and a second side face 51d. The first surface 51a is an example of a first face. The second surface 51b is an example of a second face.

The first surface 51a is a substantially flat face having a substantially square shape oriented in a direction along the Y-axis in FIGS. 1 to 3. The direction the first surface 51a is oriented is not limited thereto. For example, the direction the first surface 51a is oriented changes when the watchband 22 of the wristwatch 11 is deformed or the healthcare device 12 is moved. The second surface 51b is a substantially flat face having a substantially square shape located on the opposite side of the first surface 51a.

The first side face 51c is a substantially flat face having a substantially oval shape oriented in a direction orthogonal to (intersecting) the direction the first surface 51a is oriented. In FIGS. 1 to 3, the first side face 51c is oriented in the direction along the Z-axis. The direction in which the first side face 51c is oriented is not limited thereto. The second side face 51d is a substantially flat face having a substantially oval shape located on the opposite side of the first side face 51c.

The housing 51 is provided with an opening 61. The opening 61 may be referred to as, for example, a hole, a slit, a passed portion, a fastened portion, and a holded portion. The opening 61 is extended in the direction along the Z-axis in FIGS. 1 to 3, and is opened to the first side face 51c and the second side face 51d of the housing 51. The direction the opening 61 extends is not limited thereto.

The width in the direction along the X-axis of the opening 61 is longer than the width in the direction along the X-axis of each of the first watchband 41 and the second watchband 42. Furthermore, the thickness in the direction along the Y-axis of the opening 61 is thicker than the thickness of each of the first watchband 41 and the second watchband 42. Thus, each of the first and second watchbands 41, 42 can be passed through the opening 61.

As illustrated in FIG. 1, when the first watchband 41 is passed through the opening 61, the housing 51 is attached to the first watchband 41 of the watchband 22. The housing 51 is not limited thereto, and for example, may be attached to the first watchband 41 with other components such as, for example, a clip, a snap (press stud), a band, a magnet, and a screw.

The housing 51 attached to the first watchband 41 is movable along the first watchband 41. The housing 51 may, for example, include a protrusion that limits the movement of the housing 51 by being fitted to a hole provided in the first watchband 41. Furthermore, the housing 51 may be attached to the second watchband 42 by passing the second watchband 42 through the opening 61.

As illustrated in FIGS. 2 and 3, the housing 51 further includes a first inner face 51e and a second inner face 51f. The first and second inner surfaces 51e, 51f each forms a part of the opening 61. The first inner face 51e is a substantially flat face having a substantially square shape oriented in the direction along the Y-axis in FIGS. 1 to 3. The direction in which the first inner face 51e is oriented is not limited thereto. The first inner face 51e is closer to the first surface 51a than the second inner face 51f. The second inner face 51f is a substantially flat face having a substantially square shape facing the first inner face 51e. The second inner face 51f is closer to the second surface 51b than the first inner face 51e.

The housing 51 further includes a first portion 65, a second portion 66, a third portion 67, and a fourth portion 68.

The first portion 65 includes the first surface 51a and the first inner face 51e, and is a part of the housing 51 extending in the direction along the X-axis in FIGS. 1 to 3. In other words, the first portion 65 includes a part of the housing 51 located between the first surface 51a and the first inner face 51e. The first portion 65 accommodates the first substrate 53.

The second portion 66 includes a part of the second surface 51b and the second inner face 51f, and is a part of the housing 51 extending in the direction along the X-axis in FIGS. 1 to 3. In other words, the second portion 66 includes a part of the housing 51 located between the second surface 51b and the second inner face 51f. The second portion 66 accommodates the second substrate 54.

The third portion 67 is a part of the housing 51 connecting one end of the first portion 65 and one end of the second portion 66. The third portion 67 is formed to a substantially arcuate shape but may be formed to other shapes. The third portion 67 accommodates the flexible cable 55.

The fourth portion 68 includes a part of the second surface 51b, and is connected to the other end of the first portion 65. The fourth portion 68 may be connected to the other end of the second portion 66, or may be connected to the other end of the first portion 65 and the other end of the second portion 66. The fourth portion 68 accommodates the battery 56.

Each of the first substrate 53 and the second substrate 54 is, for example, a printed circuit board (PCB). Each of the first and second substrates 53, 54 may be other substrate.

The first substrate 53 is accommodated in the first portion 65 of the housing 51 and is extended along the first portion 65, as described above. In other words, at least a part of the first substrate 53 is located between the first surface 51a of the housing 51 and the opening 61.

The second substrate 54 is accommodated in the second portion 66 of the housing 51 and is extended along the second portion 66, as described above. In other words, at least a part of the second substrate 54 is located between the second surface 51b of the housing 51 and the opening 61. The opening 61 is located between the first substrate 53 and the second substrate 54.

The flexible cable 55 is, for example, a flexible printed circuit board (FPC). The flexible cable 55 may be a flexible flat cable (FFC), an insulated wire, or another type flexible cable used for transmitting electric signals. The flexible cable 55 connects the first substrate 53 and the second substrate 54. The flexible cable 55 is more flexible than the first substrate 53 and is more flexible than the second substrate 54. The flexible cable 55 is accommodated in the third portion 67 of the housing 51 and extended along the third portion 67, as described above.

As illustrated in FIG. 3, the sensor 52 includes a first electrode 71, a second electrode 72, and an electronic component 73. Each of the first and second electrodes 71, 72 is an example of a sensing interface. The sensor 52 is not limited thereto, and for example, may include various elements such as other electronic components and a wiring pattern formed on the first and second substrates 53, 54.

The first electrode 71 is mounted on the first substrate 53. The first electrode 71 is extended from the first substrate 53 toward the first surface 51a of the housing 51. The first electrode 71 includes a first contacting face 71a. The first contacting face 71a is exposed at the first surface 51a and forms substantially the same plane as the first surface 51a. In other words, the first contacting face 71a of the first electrode 71 is provided on the first surface 51a.

The second electrode 72 is mounted on the second substrate 54. The second electrode 72 is extended from the second substrate 54 toward the second surface 51b of the housing 51. The second electrode 72 includes a second contacting face 72a. The second contacting face 72a is exposed at the second surface 51b and forms substantially the same plane as the second surface 51b. In other words, the second contacting face 72a of the second electrode 72 is provided on the second surface 51b.

The battery 56 is connected to the first substrate 53 with a cable, for example. The battery 56 supplies power to the sensor 52 by supplying power to the first substrate 53, the second substrate 54, and the flexible cable 55.

The battery 56 may be accommodated in the fourth portion 68 of the housing 51 so as to be detachable from the housing 51. The battery 56 may, for example, be charged from an external power supply through a connector mounted on the first or second substrates 53, 54 or externally charged by a Wireless power transfer with a coil arranged on the first or second substrate 53, 54.

The second portion 66 and the third portion 67 of the housing 51 made of elastomer are elastically deformable. The second portion 66 is, for example, movable between a first position P1 indicated with a solid line in FIG. 3 and a second position P2 indicated with a chain double-dashed line in FIG. 3.

A catch 66a is provided at the end of the second portion 66 facing the fourth portion 68. For example, the catch 66a can be fitted to a depression provided on the fourth portion 68. At the first position P1, the catch 66a of the second portion 66 is fitted to the depression of the fourth portion 68. The second portion 66 is thereby detachably fastened to the fourth portion 68. The second portion 66 is not limited thereto, and may be fastened in the fourth portion 68 with other means such as a protrusion, a depression, a magnet, and a hook and loop fastener.

At the second position P2, the second portion 66 is detached from the fourth portion 68. In other words, the second portion 66 is detached from the fourth portion 68 by being moved from the first position P1 to the second position P2. When the second portion 66 is moved to the second position P2, the opening 61 is opened in the direction along the Y-axis.

When the second portion 66 located at the first position P1 is fastened to the fourth portion 68, the first to fourth units 65 to 68 form a substantially annular shape. The first to fourth units 65 to 68 thereby form the opening 61.

The above healthcare device 12 is used, for example, by the user in the following manner. The method of using the healthcare device 12 is not limited to the following method.

First, the first watchband 41 is passed through the opening 61 of the housing 51 of the healthcare device 12. The healthcare device 12 is thereby attached to the first watchband 41. The first watchband 41 may be passed through the opening 61 while the second portion 66 of the housing 51 is at the first position P1 or may be passed through the opening 61 while the second portion 66 is at the second position P2.

The opening 61 is opened in the direction along the Y-axis in a state the second portion 66 is at the second position P2. Thus, the first watchband 41 can be easily passed through the opening 61 from the opened portion of the opening 61.

The watchband 22 in which the healthcare device 12 is attached to the first watchband 41 is worn around the wrist of the user. For example, the watchband 22 formed to an annular shape by fastening the second watchband 42 to the first watchband 41 with the buckle 43 is held at the wrist of the user.

When the watchband 22 of the wristwatch 11 is held at the wrist of the user, the first surface 51a of the housing 51 faces the wrist of the user. In other words, the first surface 51a faces the wrist, which is a part of the human body around which the wristwatch 11 is worn. Thus, the first surface 51a is oriented the same direction as the direction in which the inner circumferential face 22a of the watchband 22 is oriented. The healthcare device 12 may be attached to the watchband 22 so that the second surface 51b faces the wrist of the user.

The inner circumferential face 22a of the watchband 22 is a face on the inner side of the annular shaped watchband 22. The outer circumferential face 22b of the watchband 22 is the face on the outer side of the annular watchband 22 located on the opposite side of the inner circumferential face 22a. The outer circumferential face 22b is oriented in the same direction as the direction in which the second surface 51b is oriented.

The first surface 51a of the housing 51 is brought into contact with the wrist of the user. Thus, the first contacting face 71a of the first electrode 71 arranged on the first surface 51a is also brought into contact with the wrist of the user. The first contacting face 71a may be separated from the wrist of the user but may be brought into contact with the wrist of the user.

The first contacting face 71a of the first electrode 71 is electrically connected to the wrist of the user by being brought into contact with the wrist of the user. The user brings a part of the human body such as a fingertip into contact with the second contacting face 72a of the second electrode 72. The user and the first and second electrodes 71, 72 of the sensor 52 are thereby electrically connected. The second contacting face 72a of the second electrode 72 may be electrically connected to the wrist of the user, and the first contacting face 71a of the first electrode 71 may be electrically connected to the fingertip of the user.

The sensor 52 can sense a cardiac action potential of the user through the first and second electrodes 71, 72. Thus, the sensor 52 can obtain the biological information of the human body brought into contact with the first and second electrodes 71, 72. The action potential refers to a change in electrical potential associated with the passage of an impulse along the membrane of a muscle cell or nerve cell.

The healthcare device 12 transmits, for example, information of the cardiac action potential of the user sensed by the sensor 52 to other devices such as the wristwatch 11, the mobile phone, the smartphone, and the personal computer from the antenna provided in the electronic component 73. For example, the antenna may be provided on the first substrate 53 or the second substrate 54 as a component or a pattern, and is not limited to the electronic component 73. Thus, the user can measure his/her cardiac action potential with the healthcare device 12.

In the first embodiment, the sensor 52 senses the cardiac action potential of the user through the first and second electrodes 71, 72. However, the sensor 52 is not limited thereto, and may obtain other biological information of user with other elements.

For example, the sensor 52 may include a light emitting diode (LED) and a photodiode, which photodiode receives the light of the LED to sense the pulse wave of the user. For example, the sensor 52 may include a thermometer to detect the body temperature of the user.

As described above, the healthcare device 12 for sensing the cardiac action potential of the user, another healthcare device 12 for sensing the pulse wave of the user, and another healthcare device 12 for sensing the body temperature of the user may be provided. A plurality of healthcare devices 12 may be attached to the watchband 22 of the wristwatch 11.

In the healthcare device 12 of the first embodiment, the sensor 52 that obtains the biological information of the human body is accommodated in the housing 51, the housing 51 attached to the watchband 22 of the wristwatch 11. The sensor 52 is accommodated in the housing 51 and not the display unit 21 of the wristwatch 11. In other words, the sensor 52 is accommodated in the housing 51 attached to the watchband 22, the housing 51 being independent from the display unit 21. Thus, compared to when the sensor 52 is accommodated in the watch housing 31 of the display unit 21, the display unit 21 is suppressed from being enlarged and the display unit 21 can be miniaturized and thinned. Moreover, since the housing 51 is attached to the watchband 22 separate from the display unit 21, the position of the housing 51 can be freely changed and the appearance of the wristwatch 11 can be enhanced.

The sensor 52 includes the first electrode 71 provided on the first surface 51a facing a part (wrist) of the human body, around which the wristwatch 11 is worn, and obtains the biological information of the human body making contact with the first electrode 71. In other words, the sensor 52 includes the first electrode 71 for obtaining the biological information of the human body on the inner circumferential face 22a side of the watchband 22 of the wristwatch 11 brought into contact with the wrist of the human. Thus, the sensor 52 can easily obtain the biological information of the human body.

The housing 51 is attached to the watchband 22 by passing the watchband 22 through the opening 61. The housing 51 thus can be easily attached to the watchband 22 of various wristwatches 11. In other words, the healthcare device 12 is not limited to a dedicated wristwatch 11, and for example, can be attached to a commercially available wristwatch 11. Furthermore, the housing 51 of a plurality of healthcare devices 12 can each be attached to one watchband 22. Thus, the housing 51 of one or more desired healthcare devices 12 of the user can be attached to the watchband 22 of the wristwatch 11. The user can obtain one or more desired biological information by attaching the housing 51 of the healthcare device 12 having the desired function to the watchband 22 of the wristwatch 11.

The housing 51 includes elastomer. The housing 51 thus can elastically deform, whereby the first surface 51a where the first contacting face 71a of the first electrode 71 is provided can be deformed to a shape complying with the human body. Therefore, the first electrode 71 can be easily brought into contact with the human body, and the first electrode 71 is suppressed from separating from the human body. Moreover, various components such as the sensor 52 accommodated in the housing 51 can be suppressed from being damaged.

The opening 61 is located between the first substrate 53 and the second substrate 54. Thus, the first substrate 53 and the second substrate 54 can be more efficiently arranged inside the housing 51 provided with the opening 61.

The flexible cable 55 connects the first substrate 53 and the second substrate 54. A portion (flexible cable 55) connecting the first substrate 53 and the second substrate 54 can be suppressed from being damaged even when the housing 51 receives an impact.

The first electrode 71 includes the first contacting face 71a exposed at the first surface 51a. The sensor 52 obtains the biological information of the human body making contact with the first contacting face 71a of the first electrode 71. The sensor 52 thus can easily obtain the biological information of the human body.

The sensor 52 includes the second electrode 72 exposed at the second surface 51b. For example, when the user touches the second electrode 72 with the finger, the sensor 52 is electrically connected to the wrist making contact with the first electrode 71 and the finger touching the second electrode 72, and is able to obtain the biological information of the human body based on the current flowing through the human body. As the second electrode 72 is provided on the second surface 51b located on the opposite side of the first surface 51a, the user can easily touch the second electrode 72.

The battery 56 that supplies power to the sensor 52 is accommodated in the housing 51. Thus, even if the healthcare device 12 is arranged independent from the display unit 21, the sensor 52 can be operated by being supplied with power not by the power supply of the display unit 21 but from the battery 56.

The sensor 52 is embedded in the elastomer. Thus, even if the housing 51 receives impact, the sensor 52 is suppressed from being damaged.

The second portion 66 is movable to the second position P2 detached from the fourth portion 68. Thus, the opening 61 can be opened in the direction (direction along Y-axis) intersecting the direction (direction along Z-axis) in which the opening 61 extends, and the watchband 22 of the wristwatch 11 can be passed through the opening 61 from the opened portion of the opening 61. Therefore, the housing 51 of the healthcare device 12 can be suppressed from coming into contact with the buckle 43, for example, and the housing 51 can be easily attached to the watchband 22 of the wristwatch 11.

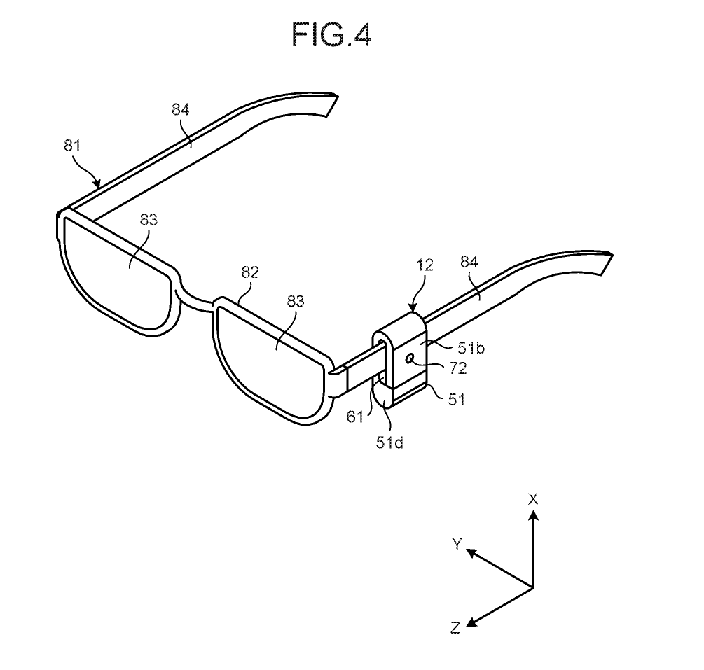

FIG. 4 is a perspective view illustrating a variant of the healthcare device 12 of the first embodiment. As illustrated in FIG. 4, the device to which the healthcare device 12 is attached to is not limited to the wristwatch 11. The healthcare device 12 may be attached to, for example, the eyeglass 81. The eyeglass 81 may be referred to as, for example, an apparatus, a device, an instrument, a tool, an accessory, and a wear.

The eyeglass 81 includes a frame 82, two lenses 83, and two temples 84. The two lenses 83 are attached to the frame 82. The two temples 84 are rotatably attached to the frame 82.

The lens 83 is used to adjust the eyesight, which is the main function of the eyeglass 81. The temple 84 is a portion that enables the frame 82, to which the lenses 83 are attached, to be worn at the head, which is a part of the human body. Thus, the temple 84 is an example of a part configured to be worn at one part of the human body.

The housing 51 of the healthcare device 12 is attached to the temple 84 by passing the temple 84 through the opening 61. When the eyeglass 81 is worn at the head of the user, the first contacting face 71a of the first electrode 71 is brought into contact with, for example, the temple of the user.

The user brings one part of the human body such as the fingertip, for example, into contact with the second contacting face 72a of the second electrode 72. The user and the first and second electrodes 71, 72 of the sensor 52 are thereby electrically connected.

As described above, the device, to which the healthcare device 12 is attached, is not limited to the wristwatch 11, and may be other devices such as the eyeglass 81. The healthcare device 12 is attached to the portion to be worn at one part of the human body of the device, independent from the portion having the main function of the device.

For example, the display unit 21 is a unit that displays time, which is the main function of the wristwatch 11. The healthcare device 12 is attached to the watchband 22 to be worn at one part (wrist) of the human body, independent from the display unit 21.

The healthcare device 12 is arranged independent from the unit having the main function of the device, so that the unit (display unit 21 of wristwatch 11, lenses 83 and frame 82 of eyeglass 81) having the main function of the device is suppressed from being enlarged.

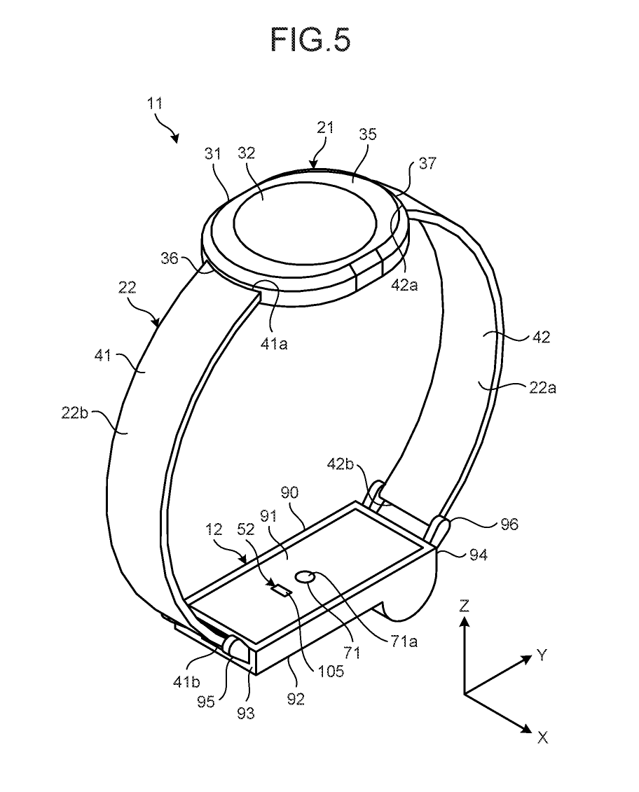

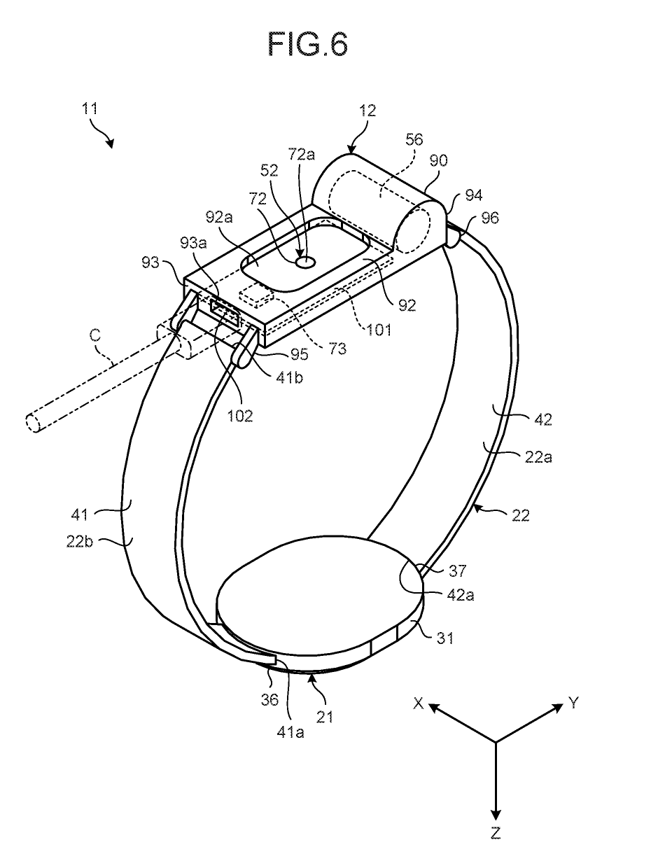

Hereinafter, a second embodiment will be described with reference to FIGS. 5 and 6. In the description of the embodiment made below, the constituent elements having functions similar to the already described constituent elements are denoted with the same reference numerals as the already described constituent elements, and the description thereof may be omitted. Furthermore, a plurality of constituent elements denoted with the same reference numerals may not necessarily have all the functions and properties in common with each other, and may have different functions and properties according to each embodiment.

FIG. 5 is a perspective view illustrating a wristwatch 11 of the second embodiment. FIG. 6 is a perspective view illustrating the wristwatch 11 of the second embodiment from another direction. As illustrated in FIGS. 5 and 6, the wristwatch 11 of the second embodiment includes the healthcare device 12 in place of the buckle 43 of the first embodiment.

In the second embodiment, the wristwatch 11 and the watchband 22 respectively are an example of the electronic device. The watchband 22 includes the healthcare device 12. The wristwatch 11 includes the display unit 21 and the watchband 22 including the healthcare device 12.

The healthcare device 12 of the second embodiment includes a housing 90. The housing 90 is, for example, made of metal. The housing 90 may be made of other materials such as, for example, synthetic resin.

The housing 90 is formed to a substantially cuboid box shape. The housing 90 may be formed to other shapes. The housing 90 includes an inner face 91, an outer face 92, a first end face 93, a second end face 94, a first attachment unit 95, and a second attachment unit 96. The inner face 91 is an example of a first face. The outer face 92 is an example of a second face. The first end face 93 is an example of a third face. The first attachment unit 95 is an example of an attachment unit.

The inner face 91 is a face formed substantially flat. The outer face 92 is a face formed substantially flat, and is located on the opposite side of the inner face 91. The inner face 91 and the outer face 92 may respectively be a curved face. In FIGS. 5 and 6, the inner face 91 and the outer face 92 are respectively oriented in the direction along the Z-axis.

The first end face 93 is one end face of the housing 90 in the direction along the Y-axis in FIGS. 5 and 6. In other words, the first end face 93 is oriented in the direction (direction along Y-axis) intersecting the direction (direction along Z-axis) in which the inner face 91 is oriented. The second end face 94 is located on the opposite side of the first end face 93. The first and second end faces 93, 94 are respectively formed to be substantially flat.

The first attachment unit 95 is provided on the first end face 93. The first attachment unit 95 is extended from the first end face 93. In FIGS. 5 and 6, the first attachment unit 95 approaches the display unit 21 the farther away from the first end face 93. In other words, the first attachment unit 95 is extended to advance in the direction the inner face 91 is oriented the farther away from the first end face 93. The first distal end portion 41b of the first watchband 41 is attached to the first attachment unit 95. For example, the first distal end portion 41b is provided with a hole through which a bar is inserted. The first attachment unit 95 includes two pieces extended from the first end face 93. The bar is detachably fixed between the two pieces to thereby attach the first distal end portion 41b of the first watchband 41 to the first attachment unit 95. The first distal end portion 41b may be integrated with the first attachment unit 95, be held between two parts of the first attachment unit 95, be fastened to the first attachment unit 95 with a pin, or be adhered onto the first attachment unit 95, for example.

A portion of the first attachment unit 95 to be attached with the first distal end portion 41b of the first watchband 41 is located in the direction the inner face 91 is oriented than the first end face 93. Thus, the first end face 93 is not covered by the first watchband 41 and is exposed.

The second attachment unit 96 is attached to the second end face 94. The second attachment unit 96 is extended from the second end face 94. In FIGS. 5 and 6, the second attachment unit 96 approaches the display unit 21 the farther away from the second end face 94. In other words, the second attachment unit 96 is extended to advance in the direction the inner face 91 is oriented the farther away from the second end face 94. The second distal end portion 42b of the second watchband 42 is attached to the second attachment unit 96. For example, the second distal end portion 42b is provided with a hole, a bar is passed through the hole. The second attachment unit 96 includes two pieces extended from the second end face 94. The bar is detachably fixed to the two pieces between the two pieces, then the second distal end portion 42b of the second watchband 42 is attached to the second attachment unit 96. The second distal end portion 42b may be integrated with the second attachment unit 96, be holed between two or more parts of the second attachment unit 96, be fastened to the second attachment unit 96 with a pin, or be adhered to the second attachment unit 96, for example.

A portion of the second attachment unit 96 to be attached with the second distal end portion 42b of the second watchband 42 is located in the direction the inner face 91 is oriented than the second end face 94. Thus, the second end face 94 is not covered by the second watchband 42 and is exposed.

Therefore, the first watchband 41 is attached to the first attachment unit 95 of the housing 90 and the second watchband 42 is attached to the second attachment unit 96. The housing 90 thereby fastens the second watchband 42 to the first watchband 41. The display unit 21 and the watchband 22 form a substantially annular shape by fastening the second watchband 42 to the first watchband 41 with the housing 90.

The first basal end portion 41a of the first watchband 41 is detachably attached to the first end portion 36 of the watch housing 31, same as the first embodiment. The second basal end portion 42a of the second watchband 42 is detachably attached to the second end portion 37 of the watch housing 31, same as the first embodiment. Thus, the watchband 22 including the healthcare device 12 can be detached from the display unit 21 of the wristwatch 11. The watchband 22 may be fixed to the display unit 21.

As illustrated in FIG. 6, the healthcare device 12 of the second embodiment includes a substrate 101, a connector 102, the sensor 52, and the battery 56. The connector 102 is, for example, also referred to as a connecting unit and a component. The substrate 101, the connector 102, the sensor 52, and the battery 56 are accommodated in the housing 90.

The substrate 101 is, for example, a PCB. The substrate 101 may be other substrates such as the FPC. The first electrode 71, the second electrode 72, and the electronic component 73 of the sensor 52 are mounted on the substrate 101. The substrate 101 is connected to the battery 56, and power is supplied from the battery 56.

The connector 102 is mounted on the substrate 101. The connector 102 is, for example, a micro-USB connector. The connector 102 is not limited thereto. The connector 102 is exposed by a hole 93a provided on the first end face 93. In other words, the connector 102 is opened at the first end face 93.

For example, a cable C of micro-USB is connected to the connector 102. The cable C is an example of an external device and is indicated with a chain double dashed line in FIG. 6. The cable C connects, for example, the healthcare device 12 and another device such as a mobile phone, a smartphone, and a personal computer. Furthermore, the battery 56 is charged from an external power supply via the cable C.

The first contacting face 71a of the first electrode 71 of the sensor 52 is exposed at the inner face 91 of the housing 90. The second contacting face 72a of the second electrode 72 of the sensor 52 is exposed at the outer face 92 of the housing 90. For example, the second contacting face 72a of the second electrode 72 is exposed at the depression 92a provided on the outer face 92.

As illustrated in FIG. 5, the sensor 52 further includes a pulse wave sensing unit 105. The pulse wave sensing unit 105 is an example of a sensing interface. The pulse wave sensing unit 105 is provided on the inner face 91 of the housing 90. The pulse wave sensing unit 105, for example, includes an LED and a photodiode accommodated in the housing 90. The pulse wave sensing unit 105 irradiates light by the LED and receives light by the photodiode.

The above wristwatch 11 is used, for example, by the user in the following manner. The method of using the wristwatch 11 is not limited to the following method.

First, the watchband 22 of the wristwatch 11 is worn at the wrist of the user. For example, the watchband 22 formed to an annular shape by fastening the second watchband 42 to the first watchband 41 with the healthcare device 12 is held on the wrist of the user.

When the watchband 22 is worn at the wrist of the user, the display unit 21 is located on the back side of the wrist, for example. The back side of the wrist is the portion of the wrist connecting to the top of the hand. The healthcare device 12, on the other hand, is located on the front side of the wrist. The front side of the wrist is the portion of the wrist connecting to the palm of the hand. Thus, the housing 90 of the healthcare device 12 is attached to the watchband 22 worn around the wrist, which is a part of the human body, on the opposite side of the display unit 21. In other words, at least a part of the housing 90 is located on the opposite side (position turned by 180°) of the display unit 21 in the watchband 22 formed to the annular shape. The position of the housing 90 is not limited thereto.

When the watchband 22 of the wristwatch 11 is held at the wrist of the user, the inner face 91 of the housing 90 faces the wrist of the user. In other words, the inner face 91 faces the wrist, which is a part of the human body where the wristwatch 11 is worn.

The inner face 91 of the housing 90 is brought into contact with the wrist of the user. Thus, the first contacting face 71a of the first electrode 71 provided on the inner face 91 is also brought into contact with the wrist of the user. The first contacting face 71a may be separated from the wrist of the user but may be brought into contact the wrist of the user.

The first contacting face 71a of the first electrode 71 is electrically connected to the wrist of the user by being brought into contact with the wrist of the user. The user thus brings a part of the human body such as the fingertip, for example, into contact with the second contacting face 72a of the second electrode 72. The user and the first and second electrodes 71, 72 of the sensor 52 are thereby electrically connected.

The sensor 52 can sense the cardiac action potential of the user through the first and second electrodes 71, 72. Thus, the sensor 52 can obtain the biological information of the human body making contact with the first and second electrodes 71, 72.

Furthermore, the pulse wave sensing unit 105 is brought into contact with the wrist of the user, same as the first electrode 71. The pulse wave sensing unit 105 senses the pulse wave of the user by, for example, having the LED irradiate the wrist of the user with light and the photodiode receive the reflected light. The sensor 52 thus can obtain the biological information of the human body brought into contact with the pulse wave sensing unit 105.

The healthcare device 12 transmits the information on the cardiac action potential and the pulse wave of the user sensed by the sensor 52, for example, from the antenna provided in the electronic component 73 to other devices such as the wristwatch 11, the mobile phone, the smartphone, and the personal computer. The antenna is not limited to be provided in the electronic component 73, the antenna may be provided on the substrate 101. Thus, the user can measure his/her cardiac action potential and the pulse wave with the healthcare device 12.

Wirings may be provided on at least one of the first watchband 41 or the second watchband 42. The healthcare device 12 may be electrically connected to the display unit 21 through the wirings. In this case, the healthcare device 12 can transmit the information of the cardiac action potential and the pulse wave of the user to the display unit 21 through the wirings.

As described above, the watchband 22 including the healthcare device 12 is detachable from the display unit 21 of the wristwatch 11. Thus, the watchband 22 is not limited to being attached to the dedicated display unit 21 of the watchband 22, and may be, for example, attached to the display unit 21 of the commercially available wristwatch 11.

In the wristwatch 11 of the second embodiment, the wristwatch 11 includes the watchband 22 to which the housing 90 is attached. In other words, the watchband 22 is integrally used with the healthcare device 12. Thus, the user can use the wristwatch 11 as a device that can obtain the biological information by attaching the watchband 22 including the healthcare device 12 to the display unit 21 of various wristwatches 11 such as the commercially available wristwatch 11.

The housing 90 fastens the second watchband 42 to the first watchband 41. Thus, the housing 90 can be used as the buckle for fastening the second watchband 42 to the first watchband 41. Therefore, another buckle becomes unnecessary, and the wristwatch 11 can be suppressed from becoming heavy.

The housing 90 includes the first attachment unit 95 located in the direction the inner face 91 is oriented than the first end face 93, the first attachment unit configured to be attached to the watchband 22. Thus, the cable C connected to the connector 102 opening to the first end face 93 is suppressed from coming into contact with the watchband 22.

The housing 90 is attached to the watchband 22 so as to be located on the opposite side of the display unit 21 while the watchband 22 is worn at one part of the human body. Thus, the user can arrange the desired one of the display unit 21 and the housing 90 on the front side of the wrist, whereby the degree of freedom of design of the wristwatch 11 can be enhanced.

The wristwatch 11 includes the display unit 21 attached with the watchband 22. In other words, the display unit 21 is integrally used with the watchband 22 and the healthcare device 12. Thus, the wristwatch 11 including the display unit 21 that displays time and the housing 90 (healthcare device 12) that accommodates the sensor 52 capable of obtaining the biological information is suppressed from becoming enlarged.

As described above, an interface such as the first or second electrodes 71, 72 may be a portion or a component with which an element such as the sensor 52 can sense or detect a physical property.

According to at least one of the above-described embodiments, the term, “obtain” is considered to include the meaning of “detect” or “sense”, for example. It can also mean “calculate”. In the first embodiment, the sensor 52 senses the cardiac action potential of the user through the first and second electrodes 71, 72. Specifically, the sensor 52 senses or detects a potential difference as the cardiac action potential with the first and second electrodes 71, 72 and outputs an electric signal according to the cardiac action potential. The sensor 52 may calculate the cardiac action potential based on other physical properties and/or information, for example.

According to at least one of the embodiment described above, the sensor for obtaining the biological information of the human body is accommodated in the housing to be attached to the watchband of the wristwatch. Since the sensor is accommodated in the housing rather than the display unit of the wristwatch, the display unit is suppressed from becoming enlarged.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a housing configured to be attached to a watchband of a wristwatch, the wristwatch including a display unit configured to display time and the watchband configured to be attached to the display unit; and
a sensor accommodated in the housing and configured to detect biological information of a human body.

2. The electronic device according to claim 1, wherein
the housing includes a first face, and
the sensor includes a sensing interface provided on the first face, and is configured to detect the biological information of the human body brought into contact with the sensing interface.

3. The electronic device according to claim 2, wherein the housing is provided with an opening through which the watchband configured to be passed.

4. The electronic device according to claim 3, wherein the housing includes an elastomer.

5. The electronic device according to claim 4, further comprising:
a first substrate; and
a second substrate, wherein
the opening is located between the first substrate and the second substrate.

6. The electronic device according to claim 5, further comprising a cable configured to connect the first substrate and the second substrate, the cable being more flexible than the first substrate.

7. The electronic device according to claim 6, wherein
the first substrate is located between the first face and the opening, and
the sensing interface includes a first electrode mounted on the first substrate and exposed at the first face.

8. The electronic device according to claim 7, wherein
the housing includes a second face located on the opposite side of the first face,
the second substrate is located between the second face and the opening, and
the sensing interface includes a second electrode mounted on the second substrate and exposed at the second face.

9. The electronic device according to claim 8, further comprising a battery accommodated in the housing, the battery configured to supply power to the sensor.

10. The electronic device according to claim 9, wherein the sensor is embedded in the elastomer.

11. The electronic device according to claim 10, wherein
the housing includes a first portion including the first face and configured to accommodate the first substrate, a second portion including the second face and configured to accommodate the second substrate, a third portion configured to connecting the first portion and the second portion and to accommodate the cable, and a fourth portion connected to one of the first portion and the second portion,
other one of the first portion and the second portion is movable between a first position of being fastened to the fourth portion and a second position of being detached from the fourth portion, and
the one of the first portion and the second portion, the other one of the first portion and the second portion located at the first position, the third portion, and the fourth portion are configured to form the opening.

12. The electronic device according to claim 2, further comprising the watchband.

13. The electronic device according to claim 12, wherein
the watchband includes a first watchband including a first end portion configured to be attached to the display unit and a second end portion located on an opposite side of the first end portion and configured to be attached to the housing, and a second watchband including a third end portion configured to be attached to the display unit; and
the housing is configured to fasten the second watchband to the first watchband.

14. The electronic device according to claim 13, further comprising:
a connector accommodated in the housing and configured to be connected to an external device; wherein
the housing includes a third face oriented in a direction intersecting the direction in which the first face is oriented, and an attachment unit located in the direction in which the first face is oriented than the third face and configured be attached to the watchband; and
the connector is configured to be opened at the third face.

15. The electronic device according to claim 14, wherein the sensing interface includes a first electrode exposed at the first face.

16. The electronic device according to claim 15, wherein
the housing includes a second face located on an opposite side of the first face, and
the sensing interface includes a second electrode exposed at the second face.

17. The electronic device according to claim 16, wherein the housing is configured to be attached to the watchband worn around one part of the human body on an opposite side of the display unit.

18. The electronic device according to claim 17, further comprising the display unit.

19. The electronic device according to claim 1, wherein the housing is configured to be attached to the watchband, the housing being independent from the display unit.

20. An electronic device comprising:
a housing independent from a device having a main function of an apparatus, the housing configured to be attached to a part configured to be worn around one part of a human body of the apparatus; and
a sensor accommodated in the housing and configured to detect biological information of the human body.
